(19) United States
(12) Patent Application Publication
(10) Pub. No.: US 2023/0311315 A1
(43) Pub. Date: Oct. 5, 2023

(54) ROBOT CONTROL DEVICE, ROBOT CONTROL METHOD, AND NON-TRANSITORY COMPUTER-READABLE STORAGE MEDIUM STORING ROBOT CONTROL PROGRAM

(71) Applicant: SEIKO EPSON CORPORATION, Tokyo (JP)

(72) Inventors: Masaki MOTOYOSHI, AZUMINO-SHI (JP); Yuma SHIMURA, MATSUMOTO-SHI (JP)

(21) Appl. No.: 18/127,017

(22) Filed: Mar. 28, 2023

(30) Foreign Application Priority Data
Mar. 30, 2022 (JP) 2022-055405

(51) Int. Cl. B25J 9/16; B23P 19/04

(52) U.S. Cl. CPC B25J 9/1661; B23P 19/04; B25J 9/1653

(57) ABSTRACT

A robot control device determines control parameters based on a table in which a correspondence relation between work contents of work to be performed by a robot and levels of the control parameters of the robot is specified. The table includes, as the work contents, conveyance work for conveying a target object and assembly work for assembling the target object and includes, as the control parameters, for each of the conveyance work and the assembly work, speed of the robot, command followability, and an operation end determination standard. A level of the speed of the conveyance work is higher than that of the assembly work. A level of the command followability of the conveyance work is lower than that of the assembly work. A level of the operation end determination standard of the conveyance work is lower than that of the assembly work.

The present application is based on, and claims priority from JP Application Serial Number 2022-055405, filed Mar. 30, 2022, the disclosure of which is hereby incorporated by standard herein in its entirety.

### BACKGROUND

### 1. Technical Field

The present disclosure relates to a robot control device, a robot control method, and a non-transitory computer-readable storage medium storing a robot control program.

### 2. Related Art

An industrial robot needs to operate according to kinds of work of operators. However, since work contents are different depending on the operators, parameters for causing the robot to operate are generally set to general-purpose values that can be widely adapted to all work regions (a movable range of the robot). When the parameters are set to the general-purpose values in this way, although there is an advantage that the robot operation can be performed in the same manner for all the work regions, conversely, it is difficult to locally improve accuracy, for example, improve accuracy of the robot operation in a certain specific work region. In view of this point, JP-A-2009-142903 (Patent Literature 1) discloses a robot control device that can set dedicated parameters for a specific work region.

However, control parameters requested by an operator such as speed and damping are different depending on a type of work performed by a robot. Therefore, a robot control device is requested to set control parameters matching demands of the operator. It is difficult for the robot control device disclosed in Patent Literature 1 to cope with this point.

### SUMMARY

A robot control device according to an aspect is a robot control device including a control unit configured to cause a robot to perform work. The control unit determines control parameters based on a table in which a correspondence relation between work contents of the work to be performed by the robot and levels of the control parameters of the robot is specified. The table includes, as the work contents, conveyance work for conveying a target object and assembly work for assembling the target object and includes, as the control parameters, for each of the conveyance work and the assembly work, speed of the robot, command followability indicating followability of the robot to a position command, and an operation end determination standard indicating a standard for determining an operation end of the robot. A level of the speed of the conveyance work is higher than a level of the speed of the assembly work. A level of the command followability of the conveyance work is lower than a level of the command followability of the assembly work. A level of the operation end determination standard of the conveyance work is lower than a level of the operation end determination standard of the assembly work.

A robot control method according to an aspect includes determining control parameters based on a table in which a correspondence relation between work contents of work to be performed by a robot and levels of the control parameters of the robot is specified. The table includes, as the work contents, conveyance work for conveying a target object and assembly work for assembling the target object and includes, as the control parameters, for each of the conveyance work and the assembly work, speed of the robot, command followability indicating followability of the robot to a position command, and an operation end determination standard indicating a standard for determining an operation end of the robot. A level of the speed of the conveyance work is higher than a level of the speed of the assembly work. A level of the command followability of the conveyance work is lower than a level of the command followability of the assembly work. A level of the operation end determination standard of the conveyance work is lower than a level of the operation end determination standard of the assembly work.

A non-transitory computer-readable storage medium storing a robot control program for determining control parameters based on a table in which a correspondence relation between work contents of work to be performed by a robot and levels of the control parameters of the robot is specified. The table includes, as the work contents, conveyance work for conveying a target object and assembly work for assembling the target object and includes, as the control parameters, for each of the conveyance work and the assembly work, speed of the robot, command followability indicating followability of the robot to a position command, and an operation end determination standard indicating a standard for determining an operation end of the robot. A level of the speed of the conveyance work is higher than a level of the speed of the assembly work. A level of the command followability of the conveyance work is lower than a level of the command followability of the assembly work. A level of the operation end determination standard of the conveyance work is lower than a level of the operation end determination standard of the assembly work.

### BRIEF DESCRIPTION OF THE DRAWINGS

FIG. 1 is a perspective view showing an overall configuration of a robot system according to a preferred embodiment.

FIG. 2 is a diagram showing a table.

FIG. 3 is a graph showing speed included in control parameters.

FIG. 4 is a graph showing command followability included in the control parameters.

FIG. 5 is a graph showing an operation end determination standard included in the control parameters.

FIG. 6 is a graph showing an operation end determination standard included in the control parameters.

### DESCRIPTION OF EXEMPLARY EMBODIMENTS

A robot control device, a robot control method, and a non-transitory computer-readable storage medium storing a robot control program of the present disclosure are explained in detail below based on a preferred embodiment shown in the accompanying drawings.

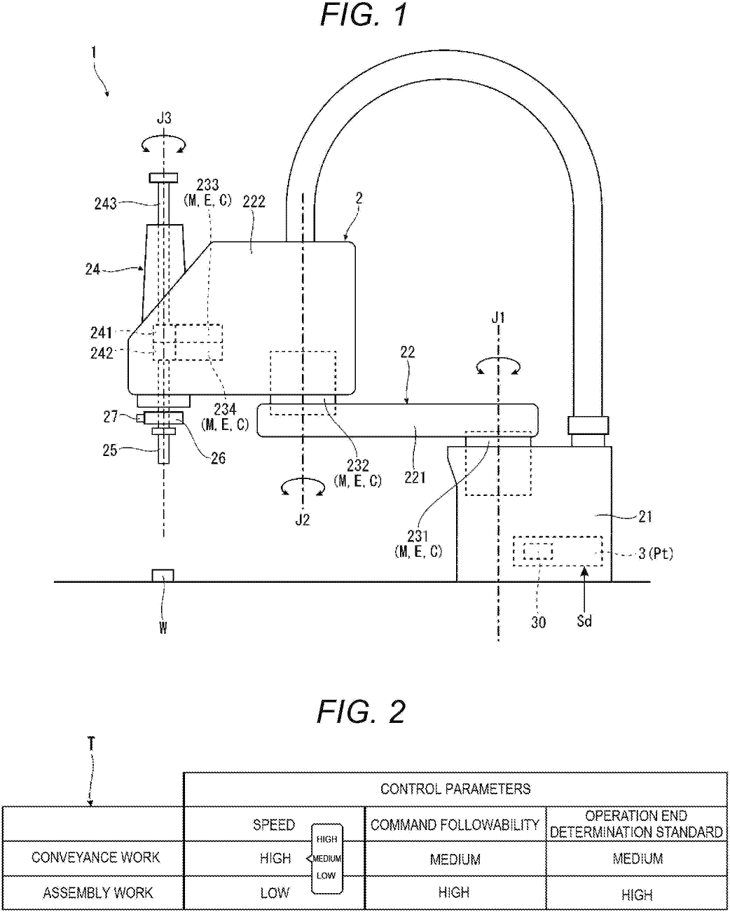

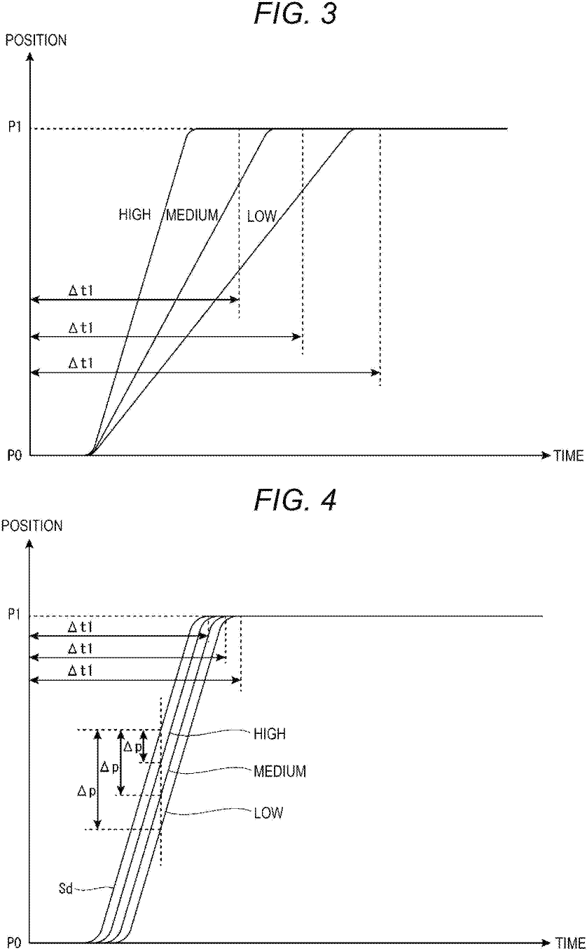

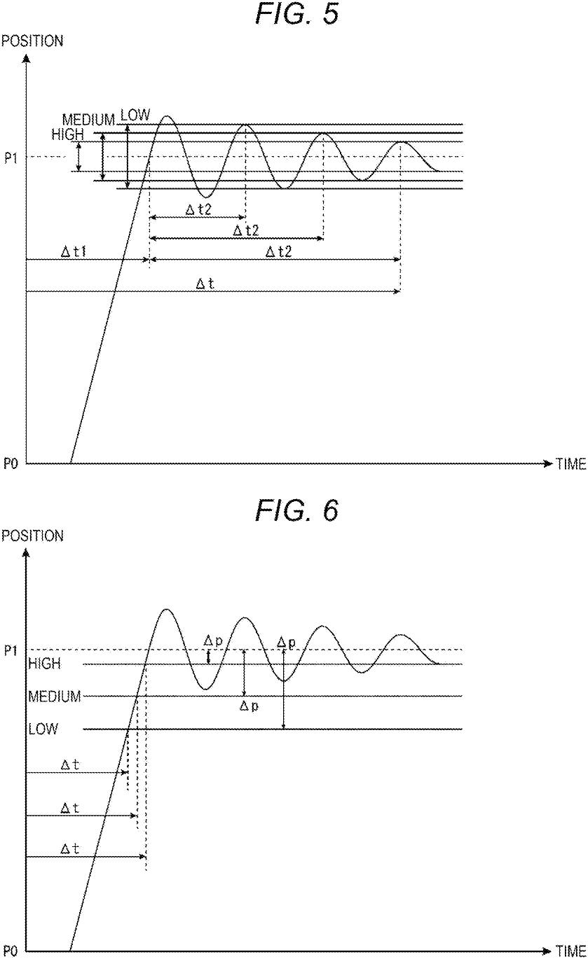

FIG. 1 is a perspective view showing an overall configuration of a robot system according to the preferred embodiment. FIG. 2 is a diagram showing a table. FIG. 3 is a graph showing speed included in control parameters. FIG. 4 is a graph showing command followability included in the control parameters. FIG. 5 is a graph showing an operation end determination standard included in the control parameters. FIG. 6 is a graph showing an operation end determination standard included in the control parameters.

A robot system 1 shown in FIG. 1 includes a robot 2 and a robot control device 3 that controls driving of the robot 2.

### Robot 2

The robot 2 is a horizontal articulated robot (a SCARA robot) and is used in, for example, kinds of work such as maintenance, conveyance, assembly, and inspection of a workpiece such as an electronic component. However, uses of the robot 2 are not particularly limited. The robot 2 is not limited to the horizontal articulated robot and may be, for example, a six-axis vertical articulated robot.

The robot 2 includes a base 21 fixed to a floor surface and a robot arm 22 coupled to the base 21. The robot arm 22 includes a first arm 221, the proximal end portion of which is coupled to the base 21, the first arm 221 being turnable around a first axis J1 with respect to the base 21, and a second arm 222, the proximal end portion of which is coupled to the distal end portion of the first arm 221, the second arm 222 being turnable around a second axis J2 parallel to the first axis J1 with respect to the first arm 221. A work head 24 is provided at the distal end portion of the second arm 222.

The work head 24 includes a spline nut 241 and a ball screw nut 242 coaxially disposed at the distal end portion of the second arm 222 and a spline shaft 243 inserted through the spline nut 241 and the ball screw nut 242. The spline shaft 243 is rotatable around a third axis J3, which is the center axis of the spline shaft 243, with respect to the second arm 222 and is capable of rising and falling in a direction extending along the third axis J3. The third axis J3 is parallel to the first axis J1 and the second axis J2.

A payload 26 for attaching an end effector 25 is provided at the lower end portion of the spline shaft 243. The end effector 25 to be attached to the payload 26 is not particularly limited and can be selected as appropriate according to work content. However, in this embodiment, a hand for attracting and gripping a target object W is used.

An inertial sensor 27 is disposed in the payload 26. Acceleration and angular velocity applied to the distal end of the robot arm 22 can be detected.

A driving device 231 that causes the first arm 221 to turn around the first axis J1 with resect to the base 21 is provided in the base 21. A driving device 232 that causes the second arm 222 to turn around the second axis J2 with respect to the first arm 221, a driving device 233 that causes the spline nut 241 to rotate and causes the spline shaft 243 to rotate around the third axis J3, and a driving device 234 that causes the ball screw nut 242 to rotate and causes the spline shaft 243 to rise and fall in the direction extending along the third axis J3 are provided in the second arm 222.

The driving devices 231, 232, 233, and 234 include motors M functioning as driving sources, controllers C that control driving of the motors M, and encoders E that detect rotation amounts of the motors M. The driving devices 231, 232, 233, and 234 drive the motors M according to servo control for feeding back outputs of the encoders E.

### Robot Control Device 3

The robot control device 3 includes, for example, a control unit 30 that controls to drive, based on a position command Sd from a not-shown host computer, the driving devices 231, 232, 233, and 234 and the end effector 25 independently from one another and causes the robot 2 to perform predetermined work.

The robot control device 3 is configured from, for example, a computer and includes a processor that processes information, a memory communicably connected to the processor, and an external interface that performs connection to an external device. A robot control program Pt executable by the processor is stored in the memory. The processor reads the robot control program Pt stored in the memory and executes a control method explained below.

In order to cause the robot 2 to operate, it is necessary to set in advance various control parameters necessary for controlling the robot 2 such as a movable range, speed, command followability, and an operation end determination standard of the robot arm 22. In the robot field, in general, a manufacturer sets these control parameters as appropriate at a shipment time considering safety, operability, and the like. However, contents of work to be performed by the robot 2 are different depending on operators and optimum control parameters are also different depending on the work contents. Therefore, in general, the manufacturer sets, as initial values, general-purpose control parameters in order to make it possible to widely apply the control parameters to various kinds of work.

However, with the general-purpose control parameters, accuracy of work requested by an operator is likely to be insufficient. The operator can change the control parameters according to work content. However, in this case, sufficient knowledge concerning robot control is necessary. Therefore, the robot control device 3 stores a table T including a plurality of work contents, suitable control parameters being associated with each of the work contents. The robot control device 3 is configured to set control parameters based on the table T.

As shown in FIG. 2, the table T includes, as the work contents, conveyance work for conveying the target object W and assembly work for assembling the target object W. The assembly work is not particularly limited. Examples of the assembly work include work for assembling the target object W to another component with screw clamping, screwing, fitting, or the like, work for forming a hole in the target object W with a drill or the like, and work for deforming the target object W with embossing, folding, or the like.

The table T includes control parameters suitable for work respectively for the conveyance work and the assembly work. The table T includes speed, command followability, and an operation end determination standard as control parameters. The control parameters are respectively selected from three levels of “high”, “medium”, and “low”. That is, in the table T, a correspondence relation between work contents and levels of control parameters is specified. However, the number of levels is not particularly limited and may be two or may be four or more. The control parameters may be substantially stepless.

The speed included in the control parameters indicates speed of the robot arm 22. As shown in FIG. 3, as the level is higher, the speed of the robot arm 22 is higher. Therefore, as the level of the speed is higher, a time Δt1 until the robot arm 22 reaches an objective position P1 from a present position P0 is shorter. The speed includes at least one of absolute speed, acceleration, deceleration, angular acceleration, and angular deceleration.

The command followability indicates followability of the robot 2 to the position command Sd. As shown in FIG. 4, as the level is higher, the followability of the robot 2 to the position command Sd is higher. Therefore, as the level of the command followability is higher, a difference Δp between a position based on the position command Sd during movement to the objective position P1 and an actual position is smaller. The time Δt1 until the robot arm 22 reaches the objective position P1 from the present position P0 is shorter.

The operation end determination standard indicates a standard for determining an end of one operation of the robot 2. It is determined that an operation has ended when the amplitude of vibration remaining after the robot arm 22 reaches the objective position P1 (hereinafter referred to as “residual vibration” as well) is equal to or smaller than a predetermined value. That is, as shown in FIG. 5, as the level of the operation end determination standard is higher, the amplitude is smaller and a time Δt2 until the operation end is determined after the robot arm 22 reaches the objective position P1 is longer.

A method of detecting the actual position and the residual vibration of the robot arm 22 is not particularly limited. For example, the actual position and the residual vibration can be detected based on an output of the inertial sensor 27. The actual position and the residual vibration can be detected based on outputs from the encoders E included in the driving devices 231, 232, 233, and 234. With such a detection method, it is possible to easily and accurately detect the actual position and the residual vibration of the robot arm 22.

In this way, a work time Δt required for one operation of the robot 2 is determined by a total of the time Δt1 until the robot arm 22 reaches the objective position P1 from the present position P0 and the time Δt2 until the operation end is determined after the robot arm 22 reaches the objective position P1. That is, Δt= Δt1 +Δt2. As the levels of the speed and the command followability are set higher, the time Δt1 tends to be shorter because the speed of the robot 2 is higher and, on the other hand, the time Δt2 tends to be longer because the residual vibration is larger. Conversely, as the levels of the speed and the command followability are set lower, the time Δt1 tends to be longer because the speed of the robot 2 is lower and, on the other hand, the time Δt2 tends to be shorter because the residual vibration is smaller.

The operation end determination standard is not limited to the amplitude of the residual vibration explained above. It may be determined that the operation has ended when the difference Δp between the objective position P1 and the actual position is equal to or smaller than a predetermined value. That is, as shown in FIG. 6, as the level of the operation end determination standard is higher, the difference Δp is smaller and the work time Δt is longer.

Depending on work content, the work time Δt is prioritized over the position accuracy. In this case, it is preferable to increase the levels of the speed and the command followability and reduce the level of the operation end determination standard. Depending on work content, the position accuracy is prioritized over the work time Δt. In this case, it is preferable to reduce the levels of the speed and the command followability and increase the level of the operation end determination standard. In this way, preferable control parameters are different depending on work content.

In the conveyance work, high work speed is requested. Therefore, it is effective to respectively increase the levels of the speed and the command followability. Consequently, it is possible to reduce the work time Δt and repeatedly perform the conveyance work many times at a short time interval. In the conveyance work, high position accuracy is necessary respectively when the target object W is gripped and when the gripped target object W is placed. Therefore, it is effective to set the level of the operation end determination standard high to a certain degree while avoiding the work time Δt becoming excessively long. Accordingly, as shown in FIG. 2, the control parameters of the conveyance work are set to speed “high”, command followability “medium”, and an operation end determination standard “medium”.

On the other hand, in the assembly work, high command followability is requested because positional deviation is directly related to deterioration in assembly accuracy. Therefore, it is effective to increase the level of the command followability. Consequently, the difference Δp between the position command Sd and the actual position decreases. It is possible to perform the assembly work with excellent accuracy. In the assembly work, it is effective to reduce the level of the speed for assembly accuracy improvement and cause the robot 2 to slowly operate. In the assembly work, it is effective to increase the level of the operation end determination standard for assembly accuracy improvement and cause the robot 2 to perform the next operation in a state in which the residual vibration is smaller. Accordingly, the control parameters of the assembly work are set to speed “low”, command followability “high”, and an operation end determination standard “high”.

The level of the speed of the conveyance work is higher than the level of the speed of the assembly work. The level of the command followability of the conveyance work is lower than the level of the command followability of the assembly work. The level of the operation end determination standard of the conveyance work is lower than the level of the operation end determination standard of the assembly work. Consequently, it is possible to perform the conveyance work and the assembly work respectively with appropriate control parameters.

However, the levels of the items of the control parameters of the conveyance work are not particularly limited if the level of the speed satisfies a relation of the conveyance work>the assembly work, the level of the command followability satisfies a relation of the conveyance work<the assembly work, and the level of the operation end determination standard satisfies a relation of the conveyance work<the assembly work. For example, depending on a conveyance distance of the target object W, it is possible to achieve a reduction in the work time Δt when the level of the speed is set to “medium” and set the level of the command followability to “low”. In that case, the level of the speed may be set to “medium” and the level of the command followability may be set to “low”. When position accuracy is not requested and the work time Δt is desired to be further reduced, the level of the operation end determination reference may be set to “low”.

Similarly, the levels of the items of the control parameters of the assembly work are not particularly limited if the level of the speed satisfies a relation of the conveyance work>the assembly work, the level of the command followability satisfies a relation of the conveyance work<the assembly work, and the level of the operation end determination standard satisfies a relation of the conveyance work<the assembly work. For example, depending on a moving distance of the robot 2 or the mass, the material, the shape, or the like of the target object W, residual vibration less easily occurs. In such a case, the speed may be set to “medium” to achieve a reduction in the work time Δt. In the case of work not requiring very high position accuracy, the operation end determination standard may be set to “medium”.

The table T is explained above. The robot control device 3 determines control parameters based on the table T. Representatively, the table T and work content received from the operator are compared to determine control parameters. The robot control device 3 displays a graphic interface on a display device such as a monitor and the operator selects work content via the graphic interface. When receiving the work content from the operator via the graphic interface, the robot control device 3 sets control parameters of the selected work content as control parameters of the robot 2. However, a method of determining control parameters is not particularly limited. For example, the robot control device 3 may select work content based on an operation program created by the operator and set control parameters of the selected work content as the control parameters of the robot 2.

With such a robot control device 3, it is possible to set control parameters matching work contents. Therefore, it is possible to efficiently perform respective kinds of work. Simply by selecting objective work content or work content close to the objective work content from a plurality of work contents set in advance, control parameters suitable for work having the work content are automatically set. Therefore, even an operator having insufficient knowledge concerning robot control can easily set control parameters suitable for work content.

The robot control device 3 can respectively change, according to a request from the operator, the levels of the items of the control parameters, that is, the speed, the command followability, the work end determination standard stored in the table T. The operator can request, for example, via the graphic interface displayed on the display device, a change of the control parameters set in the table T. The robot control device 3 changes the levels of the items according to a request from the operator. With such a configuration, it is possible to set control parameters more specialized for work content of the operator.

In particular, in this embodiment, the items of the control parameters are selected from the three levels of “high”, “medium”, and “low”. Therefore, even an operator having insufficient knowledge concerning robot control can intuitively and easily change the control parameters. The robot control device 3 may automatically perform the change of the control parameters based on a work result of the robot 2.

The robot system 1 is explained above. The robot control device 3 included in such a robot system 1 includes the control unit 30 that causes the robot 2 to perform work. The control unit 30 determines control parameters based on the table T in which a correspondence relation between work contents of work to be performed by the robot 2 and levels of control parameters of the robot 2 is specified. The table T includes, as the work contents, conveyance work for conveying the target object W and assembly work for assembling the target object W and includes, as the control parameters, for each of the conveyance work and the assembly work, speed of the robot 2, command followability indicating followability of the robot 2 to a position command, and an operation end determination standard indicating a standard for determining an operation end of the robot 2. A level of the speed of the conveyance work is higher than a level of the speed of the assembly work. A level of the command followability of the conveyance work is lower than a level of the command followability of the assembly work. A level of the operation end determination standard of the conveyance work is lower than a level of the operation end determination standard of the assembly work.

Consequently, it is possible to perform the conveyance work and the assembly work respectively with appropriate control parameters. For example, simply by selecting objective work content or work content close to the objective work content from the conveyance work and the assembly work, control parameters suitable for work having the work content are automatically set. Therefore, even an operator having insufficient knowledge concerning robot control can easily set control parameters suitable for work content.

As explained above, the operation end determination standard is based on the difference Δp between the objective position P1 based on the position command Sd and the actual position. The difference Δp is smaller as the level of the operation end determination standard is higher. Consequently, it is possible perform the conveyance work and the assembly work respectively with appropriate control parameters.

As explained above, the operation end determination standard is based on the amplitude of the residual vibration. The amplitude is smaller as the level of the operation end determination standard is higher. Consequently, it is possible to perform the conveyance work and the assembly work respectively with appropriate control parameters.

As explained above, the level of the speed can be changed according to a request from the operator. Consequently, it is possible to set a level of the speed specialized for work content of the operator. In particular, in this embodiment, the speed is selected from the three levels of “high”, “medium”, and “low”. Therefore, even an operator having insufficient knowledge concerning robot control can intuitively and easily change the level of the command followability.

As explained above, the level of the command followability can be changed according to a request from the operator. Consequently, it is possible to set a level of the command followability specialized for work content of the operator. In particular, in this embodiment, the command followability is selected from the three levels of “high”, “medium”, and “low”. Therefore, even an operator having insufficient knowledge concerning robot control can intuitively and easily change the level of the command followability.

As explained above, the level of the operation end determination standard can be changed according to a request from the operator. Consequently, it is possible to set a level of the operation end determination standard specialized for work content of the operator. In particular, in this embodiment, the operation end determination standard is selected from the three levels of “high”, “medium”, and “low”. Therefore, even an operator having insufficient knowledge concerning robot control can intuitively and easily change the operation end determination standard.

As explained above, the robot control method includes determining control parameters based on the table T in which a correspondence relation between work contents of work to be performed by the robot 2 and levels of control parameters of the robot 2 is specified. The table T includes, as the work contents, conveyance work for conveying the target object W and assembly work for assembling the target object W and includes, as the control parameters, for each of the conveyance work and the assembly work, speed of the robot 2, command followability indicating followability of the robot 2 to a position command, and an operation end determination standard indicating a standard for determining an operation end of the robot 2. A level of the speed of the conveyance work is higher than a level of the speed of the assembly work. A level of the command followability of the conveyance work is lower than a level of the command followability of the assembly work. A level of the operation end determination standard of the conveyance work is lower than a level of the operation end determination standard of the assembly work.

Consequently, it is possible to perform the conveyance work and the assembly work respectively with appropriate control parameters. For example, simply by selecting objective work content or work content close to the objective work content from the conveyance work and the assembly work, control parameters suitable for work having the work content are automatically set. Therefore, even an operator having insufficient knowledge concerning robot control can easily set control parameters suitable for work content.

As explained above, the robot control program Pt determines control parameters based on the table T in which a correspondence relation between work contents of work to be performed by the robot 2 and levels of control parameters of the robot 2 is specified. The table T includes, as the work contents, conveyance work for conveying the target object W and assembly work for assembling the target object W and includes, as the control parameters, for each of the conveyance work and the assembly work, speed of the robot 2, command followability indicating followability of the robot 2 to a position command, and an operation end determination standard indicating a standard for determining an operation end of the robot 2. A level of the speed of the conveyance work is higher than a level of the speed of the assembly work. A level of the command followability of the conveyance work is lower than a level of the command followability of the assembly work. A level of the operation end determination standard of the conveyance work is lower than a level of the operation end determination standard of the assembly work.

Consequently, it is possible to perform the conveyance work and the assembly work respectively with appropriate control parameters. For example, simply by selecting objective work content or work content close to the objective work content from the conveyance work and the assembly work, control parameters suitable for work having the work content are automatically set. Therefore, even an operator having insufficient knowledge concerning robot control can easily set control parameters suitable for work content.

The robot control device, the robot control method, and the non-transitory computer-readable storage medium storing the robot control program of the present disclosure are explained above based on the embedment shown in the drawings. However, the present disclosure is not limited to the embodiment. The components of the units can be replaced with any components having the same functions. Any other components may be added to the present disclosure.

What is claimed is:

1. A robot control device comprising a processor configured to cause a robot to perform work, wherein
the processor determines control parameters based on a table in which a correspondence relation between work contents of the work to be performed by the robot and levels of the control parameters of the robot is specified,
the table includes, as the work contents, conveyance work for conveying a target object and assembly work for assembling the target object and includes, as the control parameters, for each of the conveyance work and the assembly work, speed of the robot, command followability indicating followability of the robot to a position command, and an operation end determination standard indicating a standard for determining an operation end of the robot,
a level of the speed of the conveyance work is higher than a level of the speed of the assembly work,
a level of the command followability of the conveyance work is lower than a level of the command followability of the assembly work, and
a level of the operation end determination standard of the conveyance work is lower than a level of the operation end determination standard of the assembly work.

2. The robot control device according to claim 1, wherein
the operation end determination standard is based on a difference between an objective position based on the position command and an actual position, and
the difference is smaller as a level of the operation end determination standard is higher.

3. The robot control device according to claim 1, wherein
the operation end determination standard is based on amplitude of residual vibration, and
the amplitude is smaller as a level of the operation end determination standard is higher.

4. The robot control device according to claim 1, wherein a level of the speed is changed according to a request from an operator.

5. The robot control device according to claim 1, wherein a level of the command followability is changed according to a request from an operator.

6. The robot control device according to claim 1, wherein a level of the operation end determination standard is changed according to a request from an operator.

7. A robot control method comprising determining control parameters based on a table in which a correspondence relation between work contents of work to be performed by a robot and levels of the control parameters of the robot is specified, wherein
the table includes, as the work contents, conveyance work for conveying a target object and assembly work for assembling the target object and includes, as the control parameters, for each of the conveyance work and the assembly work, speed of the robot, command followability indicating followability of the robot to a position command, and an operation end determination standard indicating a standard for determining an operation end of the robot,
a level of the speed of the conveyance work is higher than a level of the speed of the assembly work,
a level of the command followability of the conveyance work is lower than a level of the command followability of the assembly work, and
a level of the operation end determination standard of the conveyance work is lower than a level of the operation end determination standard of the assembly work.

8. A non-transitory computer-readable storage medium storing a robot control program for determining control parameters based on a table in which a correspondence relation between work contents of work to be performed by a robot and levels of the control parameters of the robot is specified, wherein
the table includes, as the work contents, conveyance work for conveying a target object and assembly work for assembling the target object and includes, as the control parameters, for each of the conveyance work and the assembly work, speed of the robot, command followability indicating followability of the robot to a position command, and an operation end determination standard indicating a standard for determining an operation end of the robot,
a level of the speed of the conveyance work is higher than a level of the speed of the assembly work,
a level of the command followability of the conveyance work is lower than a level of the command followability of the assembly work, and
a level of the operation end determination standard of the conveyance work is lower than a level of the operation end determination standard of the assembly work.
